(19) United States
(12) Patent Application Publication
(10) Pub. No.: US 2024/0351556 A1
(43) Pub. Date: Oct. 24, 2024

(54) METHOD FOR CONTROLLING A DEVICE FOR TREATING A VEHICLE WINDSCREEN WITH A HYDROPHOBIC LIQUID

(71) Applicant: VALEO SYSTÈMES D'ESSUYAGE, LE MESNIL SAINT DENIS (FR)

(72) Inventors: Frederic Giraud, Le Mesnil Saint Denis (FR); Alexandre Filloux, Le Mesnil Saint Denis (FR)

(73) Assignee: Valeo Systèmes d'Essuyage, Le Mesnil Saint Denis (FR)

(21) Appl. No.: 18/285,208

(22) PCT Filed: Mar. 25, 2022
(86) PCT No.: PCT/EP2022/058027

§ 371 Date: Sep. 29, 2023

(30) Foreign Application Priority Data
Mar. 29, 2021 (FR) 2103222

(51) Int. Cl. B60S 1/48; B60S 1/08; B60S 1/52

(52) U.S. Cl. CPC B60S 1/485; B60S 1/08; B60S 1/524

(57) ABSTRACT

The invention relates to a control method (1) for controlling a treatment device (30) for treating a windscreen (31) of a vehicle (3), said treatment device (30) comprising at least one wiping system (300) comprising at least one spraying device (3000) having at least one opening (3000a) through which a hydrophobic liquid (Lq) can be sprayed onto said windscreen (31), said control method (1) performing at least one treatment cycle periodically and comprising the steps of: —recovering at least one data item representative of a state of the vehicle; —processing the recovered at least one data item representative of the state of the vehicle; —verifying the fulfilment of at least one criterion for activating the spraying device (3000) as a function of the processed at least one data item representative of the state of the vehicle; —activating the spraying device if the at least one criterion for activating the spraying device has been met.

The present invention relates to a method for controlling a device for treating a windshield of a vehicle. It is particularly applicable in motor vehicles, but is not limited thereto.

A person skilled in the art knows, notably from published patent application FR 3068938 of the Applicant, a method for controlling a device for treating a windshield of a vehicle, said treatment device comprising at least one wiper blade, the control method comprising the steps of activating the treatment device in order to spray a hydrophobic liquid onto the windshield of the vehicle when said at least one wiper blade is in a high position. Said at least one wiper blade moves on the windshield and comprises orifices, through which the hydrophobic liquid can be sprayed. Said at least one wiper blade is connected to a hydrophobic liquid reservoir.

After being applied to the windshield, the hydrophobic liquid must dry for approximately 15 minutes and then be wiped in order to remove the excess hydrophobic liquid.

This prior art proposes using the equipment of the vehicle to spray/spread hydrophobic liquid onto a window of the vehicle. Thus, applying and spreading the hydrophobic product onto the window can occur via the wiping system by remotely controlling the method. This control can be carried out by a user from the dashboard of the vehicle or even remotely, for example, by means of an application of a mobile phone or a tablet.

Said control method of the prior art requires human intervention, since it is the user who manually initiates (remotely or otherwise) the control method as they request. This therefore implies a certain amount of discipline on the part of the user in order to remember to periodically and regularly initiate the hydrophobic treatment of the windshield in order for the wiping system to operate under optimum operating conditions.

The aim of the present invention is to propose a method for controlling a treatment device for treating a windshield of an automatic and autonomous vehicle in which human intervention is no longer necessary.

Furthermore, the present invention proposes a method for controlling a treatment device for treating a windshield of a vehicle that is initiated periodically, automatically and autonomously, while forecasting the conditions in which carrying out the treatment with the hydrophobic liquid is not recommended.

To this end, the invention proposes a method for controlling a treatment device for treating a windshield of a vehicle, said treatment device comprising at least one wiping system comprising at least one spraying device having at least one orifice, through which a hydrophobic liquid can be sprayed onto said windshield, characterized in that said control method periodically initiates at least one processing cycle comprising the following steps:
retrieving at least one datum representing a state of the vehicle;
processing the at least one retrieved datum representing the state of the vehicle;
checking the fulfilment of at least one criterion for activating the spraying device as a function of the at least one processed datum representing the state of the vehicle;
activating the spraying device if the at least one criterion for activating the spraying device is fulfilled.

The control method according to the invention allows the hydrophobic treatment of the windshield to be initiated automatically, periodically and autonomously when the treatment is required so that the wiping system operates under optimal operating conditions. Thus, the user does not need to be periodically preoccupied with initiating the hydrophobic treatment, since it is managed periodically, automatically and autonomously by the electronic control unit of the control system according to the invention.

By way of an example, the processing cycle is initiated between one and three months after the last processing cycle.

According to one non-limiting embodiment, the processing cycle of the control method according to the invention comprises the following steps:
retrieving a plurality of data representing a state of the vehicle;
processing the plurality of retrieved data representing a state of the vehicle;
checking the fulfilment of a plurality of criteria for activating the spraying device as a function of the plurality of processed data representing the state of the vehicle;
activating the spraying device if each criterion from among the plurality of criteria for activating the spraying device is fulfilled.

According to one non-limiting embodiment, the at least one datum representing the state of the vehicle or the plurality of data representing the state of the vehicle is selected from among: the surrounding brightness of the vehicle, the position of the vehicle, the operation of the vehicle, the presence of a person in the vicinity of said vehicle or inside said vehicle or the current time.

According to one non-limiting embodiment, the step of retrieving the at least one datum representing the state of the vehicle or the plurality of data representing the state of the vehicle is carried out continuously during the processing cycle until the at least one criterion for activating the spraying device or each criterion from among the plurality of criteria for activating the spraying device is fulfilled. In other words, the step of retrieving the at least one datum representing the state of the vehicle or the plurality of data representing the state of the vehicle is continuously carried out during the processing cycle until the spraying device is activated.

According to one non-limiting embodiment, the surrounding brightness of the vehicle is measured by means of a brightness sensor present on the vehicle.

According to one non-limiting embodiment, the position of the vehicle is located by means of a position sensor present on the vehicle, such as a geolocation device (GPS) or any other means known to a person skilled in the art.

According to one non-limiting embodiment, said vehicle is operating when at least one of these conditions is met:
the accessories of the vehicle are powered on;
the engine of the vehicle is running.

According to one non-limiting embodiment, the presence of a person in the vicinity of said vehicle is detected by said person activating an opening of the vehicle.

According to one non-limiting embodiment, the presence of a person inside said vehicle is detected by means of at least one presence sensor inside the passenger compartment of said vehicle.

According to one non-limiting embodiment, the current time is determined by means of a clock inside the motor vehicle.

According to one non-limiting embodiment, the step of processing the at least one datum representing the state of the vehicle or the plurality of data representing the state of the vehicle involves separately comparing the at least one datum representing the state of the vehicle or each datum from among the data representing the state of the vehicle with a comparative datum.

According to one non-limiting embodiment, the comparative datum is a brightness threshold. In one non-limiting example, the brightness threshold ranges between 5 Lux and 120,000 Lux.

According to one non-limiting embodiment, the comparative datum relates to the detection of a measurement of the position sensor. In one non-limiting example, the comparative datum relates to the detection of a signal of the geolocation device.

According to one non-limiting embodiment, the comparative datum relates to the non-operating state of the vehicle.

According to one non-limiting embodiment, the comparative datum relates to the non-detection of a person present in the vicinity of the vehicle or inside said vehicle.

According to one non-limiting embodiment, the comparative datum relates to a primary time range and/or a secondary time range. In one non-limiting example, the primary time range ranges between 8:00 am and 9:00 pm in summer and between 8:00 am and 6:00 pm in winter. In one non-limiting example, the secondary time range ranges between 9:00 pm and 8:00 am in summer and between 6:00 pm and 8:00 am in winter.

According to one non-limiting embodiment, the step of checking the fulfilment of the at least one criterion for activating the spraying device or each of the criteria for activating the spraying device involves comparing the at least one datum representing the state of the vehicle or each datum from among the data representing the state of the vehicle together with the corresponding comparative datum or the corresponding comparative data, respectively.

According to one non-limiting embodiment, the at least one criterion for activating the spraying device is fulfilled when the surrounding brightness of the vehicle is above the brightness threshold or when the position of the vehicle is located or when the vehicle is not operating or when a person is not present in the vicinity of the vehicle or inside said vehicle or when the current time is within a primary time range.

According to one non-limiting embodiment, each criterion from among the plurality of criteria for activating the spraying device is fulfilled when the surrounding brightness of the vehicle is above a brightness threshold and/or when the position of the vehicle is located and/or when the vehicle is not operating and/or when a person is not present in the vicinity of the vehicle or inside said vehicle and/or when the current time is within a primary time range.

According to one particular non-limiting embodiment, the spraying device is activated if all the criteria for activating the spraying device are fulfilled simultaneously.

The control method according to the invention is also particularly advantageous in that the electronic control unit forecasts the conditions in which the treatment with the hydrophobic liquid is recommended and in which the electronic control unit must or must not initiate the treatment device.

According to one non-limiting embodiment, said treatment device further comprises a drive motor for said at least one wiping system, a pipe system connected to said at least one spraying device of said wiping system and to a reservoir, and at least one pump configured to cause said hydrophobic liquid to circulate in said pipe system up to said spraying device of said wiping system, and activating the treatment device in order to spray said hydrophobic liquid onto the windshield comprises:
activating said at least one pump so as to cause said hydrophobic liquid to circulate in said pipe system up to said at least one orifice of said spraying device of the wiping system; and, simultaneously
controlling said drive motor so as to cause said wiping system to move on said windshield.

A system is also proposed for controlling a treatment device for treating a windshield of a vehicle, said treatment device comprising at least one wiping system comprising at least one spraying device having at least one orifice, through which said hydrophobic liquid can be sprayed onto said windshield, characterized in that said control system comprises at least one device for detecting at least one datum representing a state of the vehicle and an electronic control unit configured for:
processing the at least one retrieved datum representing the state of the vehicle;
checking the fulfilment of at least one criterion for activating the spraying device as a function of the at least one processed datum representing the state of the vehicle;
activating the spraying device if the at least one criterion for activating the spraying device is fulfilled.

According to one particular non-limiting embodiment, the at least one device for detecting the at least one datum representing a state of the vehicle is selected from among a brightness sensor or a position sensor of the vehicle or a sensor for turning on the vehicle or a presence sensor for detecting the presence of a person in the vicinity of the vehicle or inside the vehicle or a clock inside the motor vehicle or any other detection device known to a person skilled in the art.

In one particular embodiment of the control method according to the invention, the control method comprises the following steps:
determining, by means of a first detection device present on said vehicle, in this case a brightness sensor, the at least one datum representing the state of the vehicle, in this case the surrounding brightness of the vehicle;
comparing the brightness with a first comparative datum, in this case a brightness threshold in order to determine whether or not a first criterion for activating the spraying device has been fulfilled;
if the first criterion for activating the spraying device is not fulfilled, in this case if the brightness is below said brightness threshold, not activating said treatment device so as not to spray hydrophobic liquid onto said windshield.

The control method of this particular embodiment is also particularly advantageous in that the electronic control unit forecasts the conditions in which the treatment by the hydrophobic liquid is not recommended and in which it must not initiate the treatment device.

According to non-limiting embodiments, said control method can further comprise one or more additional features taken alone or according to all technically possible combinations, from among the following.

According to the particular embodiment of the invention, said vehicle can comprise a second detection device, in this case a geolocation device configured to retrieve a second datum representing the state of the vehicle, in this case in order to geolocate the vehicle, and said control method comprises the following steps:
determining, from the second datum representing the state of the vehicle, if a second criterion for activating the spraying device is fulfilled, in this case if the geolocation of the vehicle via the geolocation device is functional;
if at least one of the criteria for activating the spraying device is not fulfilled, in this case if the brightness is above said brightness threshold and if geolocation of the vehicle via the geolocation device is not functional, not activating said treatment device so as not to spray hydrophobic liquid onto said windshield.

If at least one of the criteria for activating the spraying device is not fulfilled then the spraying device is not activated.

According to the particular embodiment of the invention,
if the brightness is above said brightness threshold, and if geolocation of the vehicle via the geolocation device is functional, checking another datum or multiple data representing the state of the vehicle, in this case if said vehicle is operating and/or if a person is present in the vicinity of the vehicle or inside said vehicle, and if so, i.e., if at least one of the criteria for activating the spraying device is not fulfilled, not activating said treatment device so as not to spray hydrophobic liquid onto said windshield, otherwise, if each of the criteria for activating the spraying device is fulfilled, activating said treatment device so as to spray hydrophobic liquid onto said windshield.

According to the particular embodiment of the invention, said vehicle is operating when at least one of these conditions is fulfilled:
the accessories of the vehicle are powered on;
the engine of the vehicle is running.

According to the particular embodiment of the invention, the presence of a person in the vicinity of said vehicle is detected by said person activating an opening of the vehicle.

According to the particular embodiment of the invention, the presence of a person inside said vehicle is detected by means of at least one presence sensor inside the passenger compartment of said vehicle.

According to the particular embodiment of the invention, said treatment device further comprises a drive motor for said at least one wiping system, a pipe system connected to said at least one spraying device of said wiping system and to a reservoir, and at least one pump configured to cause said hydrophobic liquid to circulate in said pipe system up to said spraying device of said wiping system, and activating the treatment device in order to spray said hydrophobic liquid onto the windshield comprises:
activating said at least one pump so as to cause said hydrophobic liquid to circulate in said pipe system up to said at least one orifice of said spraying device of the wiping system; and, simultaneously
controlling said drive motor so as to cause said wiping system to move on said windshield.

According to the particular embodiment of the invention, said control method further comprises the following steps:
determining an additional datum representing the state of the vehicle, in this case the current time;
determining, from the additional datum representing the state of the vehicle, if the corresponding criterion for activating the spraying device is fulfilled, in this case if the current time is within a primary time range or a secondary time range;
if at least one of the criteria for activating the spraying device is not fulfilled, in this case if the current time is within said primary time range and if the brightness is below said brightness threshold, not activating the treatment device so as not to spray hydrophobic liquid onto said windshield;
if at least one of the criteria for activating the spraying device is not fulfilled, in this case if the current time is within said secondary time range and if the brightness is below said brightness threshold, not activating the treatment device so as not to spray hydrophobic liquid onto said windshield.

According to one non-limiting embodiment, said brightness threshold ranges between 5 Lux and 120,000 Lux. For example, said brightness threshold is equal to 20 Lux.

According to one non-limiting embodiment, the wiper blade comprises a hydraulic ramp with orifices, through which the hydrophobic liquid can be sprayed/spread onto the windshield.

According to the particular embodiment of the invention, the treatment device of the control system comprises at least one wiping system comprising at least one spraying device having at least one orifice, through which said hydrophobic liquid can be sprayed onto said windshield, the control system comprises a detection device, in this case a brightness sensor configured to determine the at least one datum representing a state of the vehicle, in this case the surrounding brightness of said vehicle, and an electronic control unit configured for:
comparing the at least one datum representing a state of the vehicle, in this case the brightness, with a comparative value, in this case a brightness threshold, in order to determine whether or not a corresponding criterion for activating the spraying device has been fulfilled;
not activating said treatment device so as not to spray hydrophobic liquid onto said windshield when the corresponding criterion for activating the spraying device is not fulfilled, in this case when the brightness is below said brightness threshold.

According to one non-limiting embodiment, said control system further comprises at least one sensor configured to detect the presence of a person in the vicinity of the vehicle or inside the passenger compartment of the vehicle.

According to one non-limiting embodiment, said control system further comprises a geolocation device configured to geolocate said vehicle.

A computer program product is also proposed comprising instructions, which, when the program is executed by a computer, cause said computer to implement the steps of the control method according to any one of the preceding features.

A non-transitory computer-readable storage medium is also proposed comprising instructions, which, when they are executed by a computer, cause the computer to execute the control method according to any one of the preceding features.

The invention and its various applications will be better understood upon reading the following description and with reference to the accompanying figures, in which:

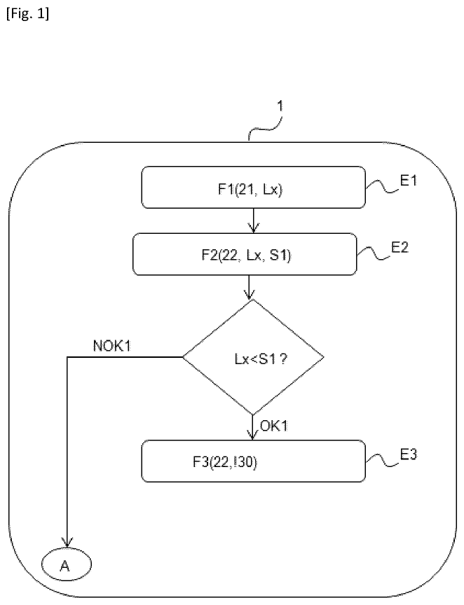

FIG. 1 is a flow chart of a method for controlling a treatment device for treating a windshield of a vehicle, according to a first non-limiting embodiment of the invention;

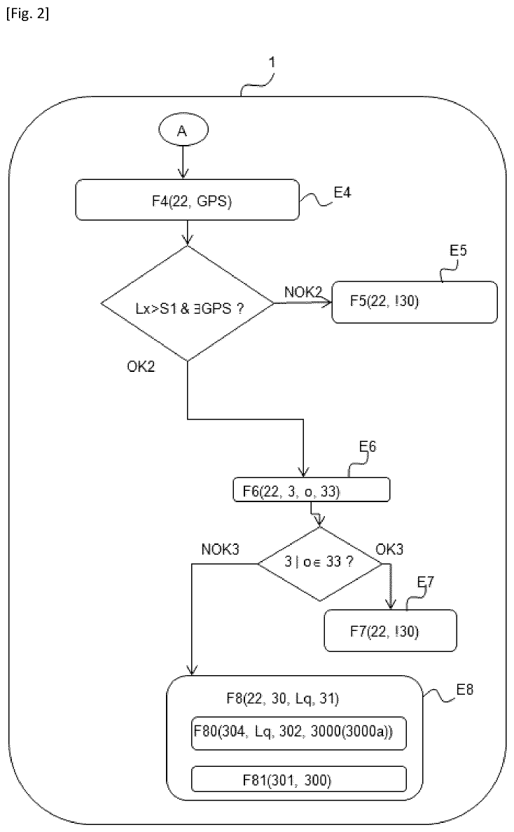

FIG. 2 is a flow chart of the control method of FIG. 1, with said control method comprising additional steps, according to one non-limiting embodiment;

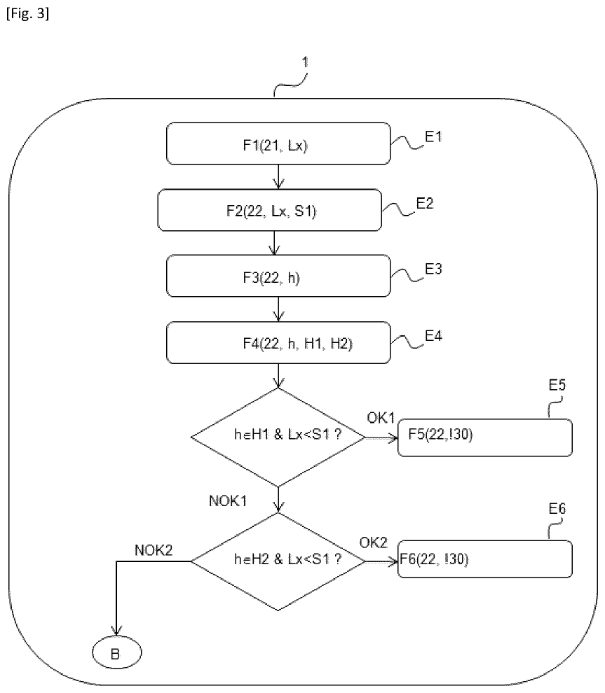

FIG. 3 is a flow chart of the control method of FIG. 2, with said control method comprising additional steps, according to one non-limiting embodiment;

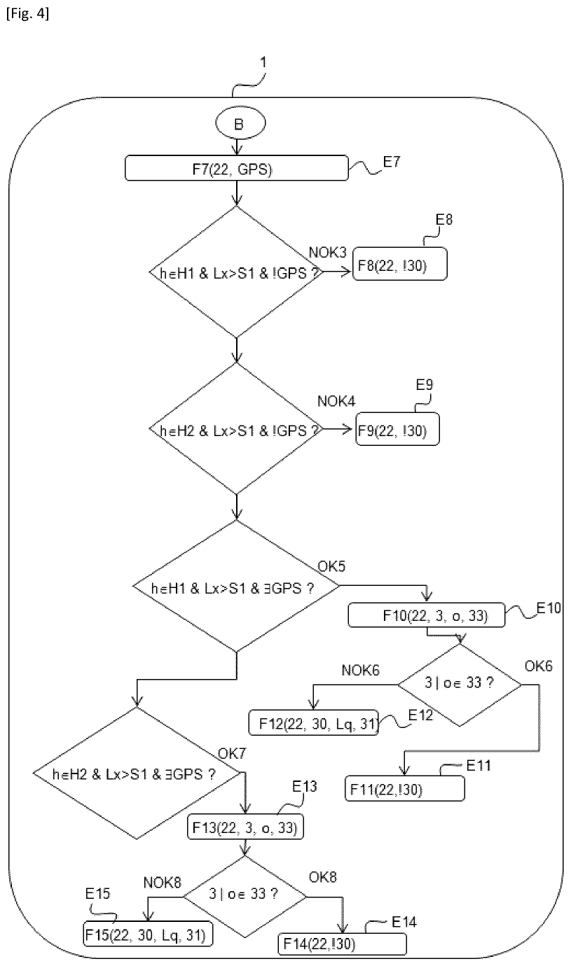

FIG. 4 is a flow chart of a method for controlling a treatment device for treating a windshield of a vehicle, according to a second non-limiting embodiment of the invention;

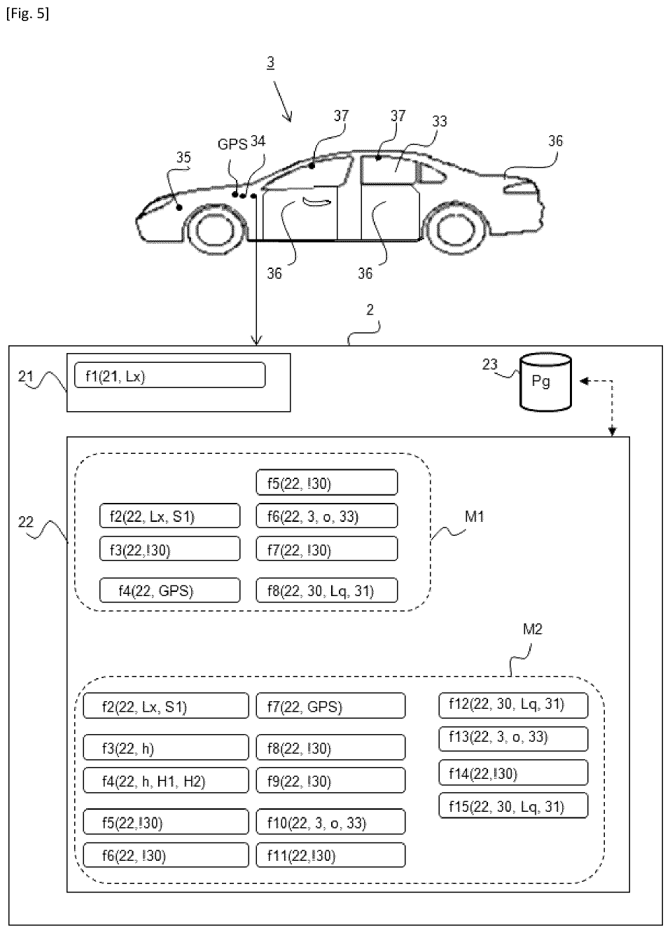

FIG. 5 is a schematic drawing of a control system configured to implement said control method of FIGS. 1 to 4, according to one non-limiting embodiment;

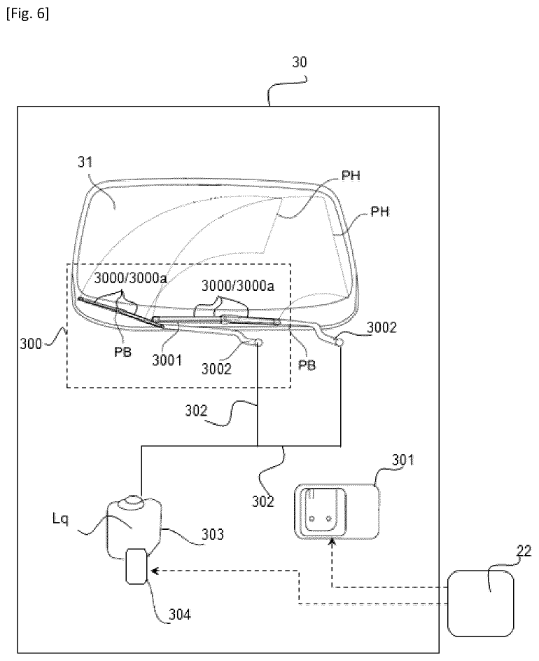

FIG. 6 is a schematic drawing of a treatment device for treating a windshield of a vehicle controlled by said control method of FIGS. 1 to 4, according to one non-limiting embodiment.

Identical elements, by structure or by function, that appear in the various figures use the same reference signs, unless otherwise specified.

The method 1 for controlling a treatment device 30 for treating a windshield 31 of a vehicle 3 according to the invention is described with reference to FIGS. 1 to 4 according to non-limiting embodiments. In one non-limiting embodiment, the vehicle 3 is a motor vehicle. A motor vehicle is understood to mean any type of motorized vehicle. This embodiment is taken as a non-limiting example throughout the remainder of the description. Throughout the remainder of the description, the vehicle 3 is thus also called motor vehicle 3. As illustrated in FIG. 5, the motor vehicle 3 further comprises accessories 34, an engine 35, openings 36. In one non-limiting embodiment, the motor vehicle 3 comprises a GPS geolocation device. In one non-limiting embodiment, the motor vehicle 3 comprises at least one presence sensor 37.

As illustrated in FIG. 6, the treatment device 30, which is controlled by the control method 1, comprises:
a wiping system 300;
a drive motor 301;
a pipe system 302;
a reservoir 303 for storing the hydrophobic liquid Lq;
at least one pump 304.

Said wiping system 300 comprises:
at least one spraying device 3000 having at least one orifice 3000a, through which a hydrophobic liquid Lq can be sprayed onto the windshield 31;
at least one wiper blade 3001 (also called blade); and
a drive arm 3002 (also called arm) connected to said at least one wiper blade 3001 via a connection device (not illustrated).

The wiping system 300 used for the hydrophobic treatment is the same as that used to clear water and dirt from the glazed surface of the windshield 31.

In one illustrated non-limiting embodiment, the wiping system 300 comprises at least one drive arm 3002 that is equipped with a wiper blade 3001 and that performs a reciprocating angular movement opposite the glazed surface of the windshield 31, between a low position PB and a high position PH.

The drive arm 3002 is notably arranged in a rod, which extends along a longitudinal axis and one end of which is connected to the wiper blade 3001 via a connection device (not illustrated) and another end of which is connected to a means for driving the wiper blade 3001, such as a drive motor 301.

In non-limiting embodiments, said at least one spraying device 3000 is located on the wiper blade 3001, or on the drive arm 3002, or on the arm/blade connection device or even on the hood of the motor vehicle 3. It is possible to have a combination of these various embodiments. In one non-limiting embodiment, the spraying device 3000 comprises a plurality of orifices 3000a. Thus, in non-limiting embodiments, the orifices 3000a are located on the wiper blade 3001, or on the drive arm 3002, or on the arm/blade connection device or even on the hood of the motor vehicle 3. The orifices 3000a can be arranged so as to spray hydrophobic liquid Lq toward the top of the wiper blades 3001, i.e., toward the top of the windshield 31, or they can be arranged so as to spray hydrophobic liquid Lq toward the bottom of the wiper blades 3001, i.e., toward the bottom of the windshield 31.

In one non-limiting embodiment, each wiper blade 3001 comprises at least one hydraulic ramp (also called ramp) having orifices 3000a, through which the hydrophobic liquid Lq can be sprayed/spread onto the windshield 31. The hydraulic ramp thus forms the spraying device 3000. In one non-limiting alternative embodiment, each wiper blade 3001 comprises two ramps, with one of the ramps having orifices 3000a configured to spray the hydrophobic liquid Lq toward the top of the windshield 31, with the other ramp having orifices 3000a configured to spray the hydrophobic liquid Lq toward the bottom of the windshield 31. These ramps can spray the liquid simultaneously or alternately depending on the direction of movement of the wiper blade 31. The one or each ramp of a wiper blade 3001 is supplied with hydrophobic liquid Lq via the pipe system 302.

The drive motor 301 is configured to drive the one or more wiper blades 3001, via the drive arms 3002, between their respective low positions PB and high positions PH.

The pipe system 302 connects the reservoir 303 to the orifices 3000a of said at least one spraying device 3000.

In one non-limiting embodiment, the reservoir 303 is a reservoir independent of the reservoir comprising windshield washer liquid, with each reservoir being associated with a different pump. In another non-limiting embodiment, the reservoir 303 can be partitioned and comprise two respective compartments for storing hydrophobic liquid Lq and washer fluid, with each compartment being associated with a different pump.

Said at least one pump 304 is associated with the reservoir 303 comprising the hydrophobic liquid Lq and is configured to circulate the hydrophobic liquid Lq in the pipe system 302 until it is discharged via the one or more orifices 3000a of said at least one spraying device 3000 onto the surface to be treated, namely the windshield.

In order to apply the hydrophobic liquid Lq to the windshield 31 of the vehicle 3, the control method 1 of the treatment device 30 is described hereafter according to two non-limiting embodiments that are respectively illustrated in FIGS. 1, 2, 3 for the first non-limiting embodiment, and in FIG. 4 for the second non-limiting embodiment. The control method 1 is implemented by a control system 2 illustrated in FIG. 5, with said control system 2 comprising a first detection device, in this case a brightness sensor 21 and an electronic control unit 22. As will be seen hereafter, conditions for activating and not activating the treatment device 30 are determined. According to the first non-limiting embodiment, the activation and non-activation conditions are a function of the data representing the state of the vehicle, such as the brightness Lx, and of the GPS geolocation device. According to the second non-limiting embodiment, the activation and non-activation conditions are a function of the data representing the state of the vehicle, such as the brightness Lx, of the GPS geolocation device, and of the time ranges H1, H2 the current time h falls within.

The first non-limiting embodiment is described hereafter with reference to FIGS. 1 to 3.

In a step E1, illustrated F1(21, Lx), the first detection device, in this case the brightness sensor 21, determines a first datum representing the state of the vehicle, in this case the surrounding brightness Lx of the motor vehicle 3. It transmits the value of the brightness Lx to the electronic control unit 22.

In a step E2, illustrated F2(22, Lx, S1), the electronic control unit 22 compares the brightness Lx with a comparative datum, in this case a brightness threshold S1. In one non-limiting embodiment, the brightness threshold S1 is equal to 20 Lux.

If the brightness Lx is below the brightness threshold S1, (branch OK1), the electronic control unit 22 does not activate the treatment device 30 so as not to spray hydrophobic liquid Lq onto the windshield 31 (step E3, illustrated F3(22, !30)). Indeed, in this case, it is possible for the motor vehicle 3 to be parked in a garage or in a non-illuminated underground parking lot. Furthermore, in order to avoid soiling the floor of the garage or of the underground parking lot, the treatment device 30 is not started, thus avoiding soiling the garage or the parking lot by spraying hydrophobic liquid Lq onto the windshield 31. Indeed, when it is sprayed onto the windshield 31, hydrophobic liquid Lq spray falls to the ground and some of the hydrophobic liquid Lq that is spread onto the windshield 31 flows onto the ground, which risks soiling the floor of the underground parking lot or of the garage in which the motor vehicle 3 is parked. If the first criterion for activating the spraying device is fulfilled, in this case if the brightness Lx is above the brightness threshold S1, (branch NOK1), the following steps are carried out as illustrated in FIG. 2.

In order to definitely check whether the motor vehicle 3 is in a garage or in an underground parking lot, a second detection device is used, in this case the GPS geolocation device of the motor vehicle 3.

Thus, as illustrated in FIG. 2, in a step E4, illustrated F4(22, GPS), the electronic control unit 22 determines whether a second criterion for activating the spraying device is fulfilled, in this case if the geolocation of the motor vehicle 3 via the GPS geolocation device is functional.

If at least one of the two criteria for activating the spraying device is not fulfilled, in this case if the brightness Lx is above said brightness threshold S1, and if geolocation of the motor vehicle 3 via the GPS geolocation device is not functional (branch NOK2), the electronic control unit 22 does not activate said treatment device 30, so as not to spray hydrophobic liquid Lq onto said windshield 31 (step E5, illustrated F5(22, !30)). Indeed, in this case, the motor vehicle 3 is in an illuminated garage or in an illuminated underground parking lot in which geolocation is not possible. Furthermore, in order to avoid soiling the floor of the garage or the underground parking lot, the treatment device 30 is not started.

It should be noted that if each of the two criteria for activating the spraying device is fulfilled, in this case if the brightness Lx is above said brightness threshold S1, and if geolocation via the GPS geolocation device is functional, this means that the motor vehicle 3 is outside. Thus, as illustrated in FIG. 2, the control method 1 further comprises the following steps.

If the brightness Lx is above said brightness threshold S1, and if geolocation via the GPS geolocation device is functional (branch OK2), the electronic control unit 22 checks that a third criterion for activating the spraying device is fulfilled on the basis of a third datum representing the state of the vehicle. In this first embodiment, the electronic control unit 22 checks that the motor vehicle 3 is operating and/or if a person o is present in the vicinity of the motor vehicle 3 or inside said motor vehicle 3, namely in the passenger compartment 33 (step E6, illustrated F6(22, 3, o, 33)). If so (branch OK3), the electronic control unit 22 does not activate the treatment device 30 so as not to spray hydrophobic liquid Lq onto the windshield 31 (step E7, illustrated F7(22, !30)).

Indeed, in this case, the motor vehicle 3 is located outside, and:
a) either it is traveling;
b) or it is stationary, but a person o is located in the passenger compartment 33 of the motor vehicle 3. This means that either the person will exit the motor vehicle 3, or they will start the motor vehicle 3 in order to use it;
c) or it is stationary, but a person o is located next to said motor vehicle 3. This means that the person o will enter the motor vehicle 3 in order to use it.

In these cases, the treatment device 30 must not be started, since otherwise:
a) either the visibility of the driver will be hindered by spraying hydrophobic liquid onto the windshield 31 when they are driving;
b) or the person located inside the motor vehicle 3 risks being sprayed with hydrophobic liquid Lq when they exit said motor vehicle 3 or their visibility will be hindered when they will start the motor vehicle 3 and drive;
c) or the person located next to the motor vehicle 3 risks being sprayed with hydrophobic liquid Lq.

In addition, if the vehicle is operating, the aerodynamic flows on the windshield generated by the movement of the vehicle or the activation of the wiping system will damage and disrupt the application of the hydrophobic liquid Lq.

Indeed, waiting for at least 15 minutes is recommended for proper application of the treatment. Thus, the hydrophobic liquid Lq has time to dry properly.

Otherwise (branch NOK3), each of the criteria for activating the spraying device is fulfilled, the electronic control unit 22 activates the treatment device 30 so as to spray hydrophobic liquid Lq onto the windshield 31 (step E8, illustrated F8(22, 30, Lq, 31)). Thus, in this case, the motor vehicle 3 is stationary because it is not operating, its passenger compartment 33 is not occupied, no one is in the vicinity of the motor vehicle 3 (this means that the motor vehicle 3 will not be subsequently used). The hydrophobic liquid Lq therefore can be applied onto the windshield 31 and it will have time to dry.

In one non-limiting embodiment, the step E8 of activating the treatment device 30 in order to spray the hydrophobic liquid Lq onto the windshield 31 comprises the following sub-steps, which are carried out simultaneously:
a sub-step E80 (illustrated F80(304, Lq, 302, 3000 (3000a))) for activating said at least one pump 304 so as to cause said hydrophobic liquid Lq to circulate in said pipe system 302 up to said at least one orifice 3000a of said at least one spraying device 3000; and
a sub-step E81 (illustrated F81(301, 300) for controlling said drive motor 301 so as to cause said wiper system 300 to move on said windshield 31.

In one non-limiting embodiment, said motor vehicle 3 is operating:
if the accessories 34 of the motor vehicle 3 are powered on; or
if the engine 35 of the motor vehicle 3 is running.

In one non-limiting embodiment, the presence of a person o inside the vehicle 3 is detected by means of said at least one presence sensor 37 inside the passenger compartment 33 of said motor vehicle 3. In non-limiting examples, said at least one presence sensor 37 is a presence sensor located on the seats of the driver or of the passenger, a camera, a biometric sensor, or any other type of presence sensors inside the passenger compartment 33. In the non-limiting example illustrated in FIG. 5, two cameras 37 have been illustrated, one located at the front and the other located at the rear in the passenger compartment 33 of the motor vehicle 3.

In one non-limiting embodiment, the presence of a person o in the vicinity of said motor vehicle 3 is detected by said person o activating an opening 36 of the motor vehicle 3. In non-limiting embodiments, an opening 36 is a door or a boot or a tailgate of the motor vehicle 3.

The second non-limiting embodiment is described hereafter with reference to FIGS. 3 and 4.

In order to refine the control method 1, time ranges H1, H2 are used to check whether it is daytime or nighttime.

In a step E1, illustrated F1(21, Lx), the first detection device, in this case the brightness sensor 21, determines the first datum representing the state of the vehicle, in this case the surrounding brightness Lx of the motor vehicle 3. It transmits the value of the brightness Lx to the electronic control unit 22.

In a step E2, illustrated F2(22, Lx, S1), the electronic control unit 22 compares the brightness Lx with a first comparative datum, in this case a brightness threshold S1. In one non-limiting embodiment, the brightness threshold S1 is equal to 20 Lux.

In a step E3, illustrated F3(22, h), the electronic control unit 22 determines an additional datum representing the state of the vehicle, in this case the current time h. In one non-limiting embodiment, it does so from a clock inside the motor vehicle 3. It should be noted that this step can be carried out at the same time as any one of steps E1 or E2 or after or before any one of these steps.

In a step E4, illustrated F4(22, h, H1, H2), the electronic control unit 22 compares the current time with an additional comparative datum by determining whether the current time h is within a primary time range H1 or a secondary time range H2.

In one non-limiting embodiment, the primary time range H1 relates to daytime and the secondary time range H2 relates to nighttime. The primary time range H1 and the secondary time range H2 can change as a function of the seasons. Thus, in one non-limiting embodiment, the primary time range H1 ranges between 08:00 hours and 21:00 hours, and the secondary time range H2 ranges between 21:00 hours and 08:00 hours. This corresponds to daytime and nighttime in summer. Thus, in another non-limiting embodiment, the primary time range H1 ranges between 08:00 hours and 18:00 hours, and the secondary time range H2 ranges between 18:00 hours and 08:00 hours. This corresponds to daytime and nighttime in winter.

If one of the criteria for activating the spraying device is not fulfilled, in this case if the current time h is within said primary time range H1 and if the brightness Lx is below a brightness threshold S1 (branch OK1), the electronic control unit 22 does not activate the treatment device 30 so as not to spray hydrophobic liquid Lq onto the windshield 31 (step E5, illustrated F5(22, !30)). Indeed, in this case, it is daytime, but it is possible for the motor vehicle 3 to be parked in a non-illuminated garage or in a non-illuminated underground parking lot. Furthermore, in order to avoid soiling the floor of the garage or the underground parking lot, the treatment device 30 is not started, thus avoiding soiling the garage or the parking lot by spraying hydrophobic liquid Lq onto the windshield 31.

Otherwise (branch NOK1), if one of the criteria for activating the spraying device is not fulfilled, in this case if the current time h is within said secondary time range H2 and if the brightness Lx is below a brightness threshold S1 (branch OK2), the electronic control unit 22 does not activate the treatment device 30 so as not to spray hydrophobic liquid Lq onto the windshield 31 (step E6, illustrated F6(22, !30). Indeed, in this case, it is nighttime, but the motor vehicle 3 may be parked in a garage or in a non-illuminated underground parking lot. If each of the criteria for activating the spraying device is fulfilled, in this case if the brightness Lx is above the brightness threshold S1, (branch NOK2), the following steps are carried out as illustrated in FIG. 4.

In the same way as for the first non-limiting embodiment, a second datum can be used that represents the state of the vehicle, in this case geolocation via a second detection device, in this case the GPS geolocation device, and the time ranges can be combined with said geolocation.

Thus, as illustrated in FIG. 4, in a step E7, illustrated F7(22, GPS), the electronic control unit 22 determines whether a second criterion for activating the spraying device is fulfilled, in this case if geolocation of the motor vehicle 3 via the GPS geolocation device is functional. It should be noted that this step can be carried out at the same time as any one of steps E1 to E5 or after or before any one of these steps.

If one of the three criteria for activating the spraying device is not fulfilled, in this case if the current time h is within said primary time range H1, if the brightness Lx is above said brightness threshold S1, and if geolocation via the GPS geolocation device is not functional (branch NOK3), the electronic control unit 22 does not activate said treatment device 30 so as not to spray hydrophobic liquid Lq onto said windshield 31 (step E8, illustrated F8(22, !30). Indeed, in this case, it is daytime, and the motor vehicle 3 is located in an illuminated garage or in an illuminated underground parking lot in which geolocation is not possible. Furthermore, in order to avoid soiling the floor of the garage or the underground parking lot, the treatment device 30 is not started.

If one of the three criteria for activating the spraying device is not fulfilled, in this case if the current time h is within said secondary time range H2, if the brightness Lx is above said brightness threshold S1, and if geolocation via the GPS geolocation device is not functional (branch NOK4), the electronic control unit 22 does not activate said treatment device 30 so as not to spray hydrophobic liquid Lq onto said windshield 31 (step E9, illustrated F9 (22, !30). Indeed, in this case, it is nighttime, and the motor vehicle 3 is in an illuminated garage or in an illuminated underground parking lot in which geolocation is not possible. Furthermore, in order to avoid soiling the floor of the garage or of the underground parking lot, the treatment device 30 is not started.

It should be noted that if geolocation via the GPS geolocation device is functional, this means that the motor vehicle 3 is outside. Thus, as illustrated in FIG. 4, the control method 1 further comprises the following steps.

If each of the three criteria for activating the spraying device is fulfilled, in this case if the current time h is within said primary time range H1, if the brightness Lx is above said brightness threshold S1, and if geolocation via the GPS geolocation device is functional (branch OK5), the electronic control unit 22 checks the (non-) production of a third datum representing the state of the vehicle, in this case the electronic control unit 22 checks that the motor vehicle 3 is operating and/or if a person o is present in the vicinity of the vehicle or inside said motor vehicle 3 (step E10, illustrated F10 (22, 3, o, 33)), and if so (branch OK6), the electronic control unit 22 does not activate the treatment device 30 so as not to spray hydrophobic liquid Lq onto the windshield 31 (step E11, illustrated F11 (22, !30)).

Indeed, in this case, it is daytime, and the motor vehicle 3 is located outside, and:
a) either it is traveling;
b) or it is stationary, but a person o is in the passenger compartment 33 of the motor vehicle 3. This means that either the person will exit the motor vehicle 3, or they will start the motor vehicle 3 in order to use it;
c) or it is stationary, but a person o is located next to said motor vehicle 3. This means that the person o will enter the motor vehicle 3 in order to use it.

In these cases, the treatment device 30 must not be started.

Otherwise (branch NOK6), if each of the criteria for activating the spraying device is fulfilled, the electronic control unit 22 activates the treatment device 30 so as to spray hydrophobic liquid Lq onto the windshield 31 (step E12, illustrated F12 (22, 30, Lq, 31)). Indeed, in this case, it is daytime, and either the motor vehicle 3 is stationary because it is not operating, or its passenger compartment 33 is not occupied or no one is in the vicinity of the motor vehicle 3 (this means that the motor vehicle 3 will not be subsequently used). The hydrophobic liquid Lq therefore can be applied onto the windshield 31 and it will have time to dry.

If one of the criteria for activating the spraying device is not fulfilled, in this case if the current time h is within said secondary time range H2, if the brightness Lx is above said brightness threshold S1, and if geolocation via the GPS geolocation device is functional (branch OK7), the electronic control unit 22 checks the (non-) fulfilment of a third criterion for activating the spraying device, namely that the vehicle is operating and/or if a person is present in the vicinity of the vehicle or inside said motor vehicle 3 (step E13, illustrated F13(22, 3, 33)), and if so (branch OK8), the electronic control unit 22 does not activate the treatment device 30 so as not to spray hydrophobic liquid Lq onto the windshield 31 (step E14, illustrated F14(22, !30)).

Thus, it is nighttime, and the motor vehicle 3 is outside and is illuminated by street lighting, and:
a) either it is traveling;
b) or it is stationary, but a person o is in the passenger compartment 33 of the motor vehicle 3. This means that either the person will exit the motor vehicle 3, or they will start the motor vehicle 3 in order to use it;
c) or it is stationary, but a person o is located next to said motor vehicle 3. This means that the person o will enter the motor vehicle 3 in order to use it.

In these cases, the treatment device 30 must not be started.

Otherwise (branch NOK8), if each of the criteria for activating the spraying device is fulfilled, the electronic control unit 22 activates the treatment device 30 so as to spray hydrophobic liquid Lq onto the windshield 31 (step E15, illustrated (step E14, illustrated F15(22, 30, Lq, 31)). Indeed, in this case, it is nighttime, and the motor vehicle 3 is not operating, its passenger compartment 33 is not occupied, no one is in the vicinity of the motor vehicle 3 (this means that the motor vehicle 3 will not be subsequently used). The motor vehicle is parked outside and is illuminated, probably in an illuminated street. The hydrophobic liquid Lq therefore can be applied onto the windshield 31 and it will have time to dry.

Thus, the control method 1 is implemented by the control system 2 of a treatment device 30 for treating a windshield 31 of a vehicle 3, said treatment device 30 comprising at least one wiping system 300 comprising at least one spraying device 3000 having an orifice 3000a, through which said hydrophobic liquid Lq can be sprayed onto said windshield 31, said control system 2 being illustrated in FIG. 5 according to one non-limiting embodiment. Said control system 2 comprises a detection device such as a brightness sensor 21 and the electronic control unit 22.

The brightness sensor 21 is configured to determine the surrounding brightness Lx of said vehicle 3 (illustrated function f1(21, Lx)).

The functions of the electronic control unit 22 are illustrated according to two non-limiting embodiments and are illustrated as dashed lines, with the second embodiment taking into account the time ranges H1 and H2.

In a first non-limiting embodiment M1, the electronic control unit 22 is configured for:
comparing a first datum representing the state of the vehicle, in this case the brightness Lx, with a first comparative datum, in this case a brightness threshold S1 (function f2(22, Lx, S1);
not activating said treatment device 30 so as not to spray hydrophobic liquid Lq onto said windshield 31 when a first criterion for activating the spraying device is not fulfilled, in this case the brightness Lx is below a brightness threshold S1 (function f3(22, !30);
determining whether a second criterion for activating the spraying device is fulfilled on the basis of a second datum representing the state of the vehicle, in this case if geolocation via the GPS geolocation device is functional (function f4(22, GPS);
not activating said treatment device 30 so as not to spray hydrophobic liquid Lq onto said windshield 31 when at least one of the two criteria for activating the spraying device is not fulfilled, in this case when the brightness Lx is above said brightness threshold S1, and when geolocation of the motor vehicle 3 via the GPS geolocation device is not functional (function illustrated f5(22, !30));
checking the fulfilment of a third criterion for activating the spraying device on the basis of a third datum representing the state of the vehicle, namely checking that the motor vehicle 3 is operating and/or if a person o is present in the vicinity of the motor vehicle 3 or inside said motor vehicle 3 when each of the two first criteria for activating the spraying device is fulfilled, in this case when the brightness Lx is above said brightness threshold S1, and when geolocation of the motor vehicle 3 via the GPS geolocation device is functional (function illustrated f6(22, 3, 0, 33));
not activating said treatment device 30 when one of the three criteria for activating the spraying device is not fulfilled, in this case when the brightness Lx is above said brightness threshold S1, when geolocation of the motor vehicle 3 via the GPS geolocation device is functional, and when the motor vehicle 3 is operating and/or if a person o is present in the vicinity of the motor vehicle 3 or inside said motor vehicle 3 (illustrated function f7(22, !30)); and
activating said treatment device 30 so as to spray hydrophobic liquid Lq onto said windshield 31 when each of the criteria for activating the spraying device is fulfilled, in this case when the brightness Lx is above said brightness threshold S1, when geolocation of the motor vehicle 3 via the GPS geolocation device is functional and when the motor vehicle 3 is not operating and/or if no one is present in the vicinity of the motor vehicle 3 or no one is present inside said motor vehicle 3 (illustrated function f8(22, 30, Lq, 31)).

In a second non-limiting embodiment, the electronic control unit 22 is configured for:
comparing a first datum representing the state of a vehicle, in this case the brightness Lx, with a first comparative datum, in this case a brightness threshold S1 (function f2(22, Lx, S1);
determining an additional datum representing the state of a vehicle, in this case the current time h (function illustrated f3(22, h));
determining the additional datum representing the state of a vehicle whether or not the corresponding criterion for activating the spraying device is fulfilled, i.e., determining whether the current time h is within a primary time range H1 or a secondary time range H2 (function illustrated f4(22, h, H1, H2);
not activating said treatment device 30 when at least one of the two criteria for activating the spraying device is not fulfilled, in this case when the brightness Lx is below said brightness threshold S1, and when the current time h is within said primary time range H1 (function illustrated f5(22, !30)); and
not activating said treatment device 30 when at least one of the two criteria for activating the spraying device is not fulfilled, in this case when the brightness Lx is below said brightness threshold S1, and when the current time h is within said secondary time range H2 (function illustrated f6(22, !30));
determining, from a second datum representing the state of a vehicle, whether or not the corresponding criterion for activating the spraying device is fulfilled, i.e., if geolocation via the GPS geolocation device is functional (function f7(22, GPS);
not activating said treatment device 30 so as not to spray hydrophobic liquid Lq onto said windshield 31 when at least one of the three criteria for activating the spraying device is not fulfilled, in this case when the current time h is within said primary time range H1, when the brightness Lx is above said brightness threshold S1, when geolocation of the motor vehicle 3 via the GPS geolocation device is not functional (function illustrated f8(22, !30));
not activating said treatment device 30 so as not to spray hydrophobic liquid Lq onto said windshield 31 when at least one of the three criteria for activating the spraying device is not fulfilled, in this case when the current time h is within said secondary time range H2, when the brightness Lx is above said brightness threshold S1, when geolocation of the motor vehicle 3 via the GPS geolocation device is not functional (function illustrated f9(22, !30));
checking, from a third datum representing the state of a vehicle, whether or not the corresponding criterion for activating the spraying device is fulfilled, i.e., checking that the motor vehicle 3 is operating and/or if a person o is present in the vicinity of the motor vehicle 3 or inside said motor vehicle 3, when the current time h is within said primary time range H1, when the brightness Lx is above said brightness threshold S1, and when geolocation of the motor vehicle 3 via the GPS geolocation device is functional (function illustrated f10(22, 3, 0, 33));
not activating said treatment device 30 when at least one of the criteria for activating the spraying device is not fulfilled, in this case when the current time h is within said primary time range H1, when the brightness Lx is above said brightness threshold S1, when geolocation of the motor vehicle 3 via the GPS geolocation device is functional, and when the motor vehicle 3 is operating and/or if a person o is present in the vicinity of the motor vehicle 3 or inside said motor vehicle 3 (function illustrated f11(22, !30)); and
activating said treatment device 30 so as to spray hydrophobic liquid Lq onto said windshield 31 when each of the criteria for activating the spraying device is fulfilled, in this case when the current time h is within said primary time range H1, when the brightness Lx is above said brightness threshold S1, when geolocation of the motor vehicle 3 via the GPS geolocation device is functional and when the motor vehicle 3 is not operating and/or if no one is present in the vicinity of the motor vehicle 3 or is present inside said motor vehicle 3 (illustrated function f12(22, 30, Lq, 31));
checking, from a third datum representing the state of a vehicle, whether or not the corresponding criterion for activating the spraying device is fulfilled, i.e., checking that the motor vehicle 3 is operating and/or if a person o is present in the vicinity of the motor vehicle 3 or inside said motor vehicle 3 when the current time h is within said secondary time range H2, when the brightness Lx is above said brightness threshold S1, and when geolocation of the motor vehicle 3 via the GPS geolocation device is functional (illustrated function f13(22, 3, 0, 33));
not activating said treatment device 30 when the current time h is within said secondary time range H2, when at least one of the criteria for activating the spraying device is not fulfilled, in this case when the brightness Lx is above said brightness threshold S1, when geolocation of the motor vehicle 3 via the GPS geolocation device is functional, and when the motor vehicle 3 is operating and/or if a person o is present in the vicinity of the motor vehicle 3 or inside said motor vehicle 3 (function illustrated f14(22, !30)); and
activating said treatment device 30 so as to spray hydrophobic liquid Lq onto said windshield 31 when each of the criteria for activating the spraying device is fulfilled, in this case when the current time h is within said secondary time range H2, when the brightness Lx is above said brightness threshold S1, when geolocation of the motor vehicle 3 via the GPS geolocation device is functional and when the motor vehicle 3 is not operating and/or if no one is present in the vicinity of the motor vehicle 3 or no one is present inside said motor vehicle 3 (illustrated function f15(22, 30, Lq, 31)).

It should be noted that the control system 2 can comprise one or more computer program products Pg comprising one or more sequences of instructions that can be executed by said electronic control unit 22, with the execution of said sequences of instructions allowing the described control method 1 to be implemented.

A computer program Pg of this type can be entered in a non-volatile writeable memory of the ROM type, or in a non-volatile rewritable memory of the EEPROM or FLASH type. Said computer program Pg can be entered in the memory in the factory, or loaded into the memory, or loaded into the memory remotely. The sequences of instructions can be sequences of machine instructions, or even sequences in a control language interpreted by the electronic control unit when they are executed. In the non-limiting example of FIG. 5, a computer program Pg is written in a memory 23 of the control system 2.

Thus, the control system 2 comprises at least one memory 23 that is coupled to said electronic control unit 22. The memory 23 is a non-transitory computer-readable storage medium comprising instructions, which, when they are executed by a computer, causes the computer to execute said control method 1.

Of course, the description of the invention is not limited to the embodiments described above and to the field described above. Thus, in another non-limiting embodiment, the (non-) activation of the treatment device 30 can be influenced by the habits of the user of the motor vehicle 3. In this case, a model of the habits of the user can be used. In this case, the electronic control unit 22 will have undertaken machine recognition learning of said model from a predetermined set of habits of the user.

Thus, the invention described above notably has the following advantages:
it allows the conditions to be checked in which the treatment device 30 must not be activated, notably when the motor vehicle 3 is in a parking lot or in a garage, if the motor vehicle 3 is traveling, if a person will imminently use the motor vehicle 3, or even if a person is in the passenger compartment 33 of the motor vehicle 3; it thus prevents the floor of a garage or of an underground parking lot from becoming wet from the hydrophobic liquid Lq, and prevents the risk of a person in the vicinity of the motor vehicle 3 from becoming wet;
it allows the conditions to be checked in which the treatment device 30 can be activated, notably when the motor vehicle 3 is stationary and is not in a parking lot or in a garage, if no one will imminently use the motor vehicle 3, or even if no one is in the passenger compartment 33 of the motor vehicle 3; it thus allows time for the hydrophobic liquid Lq to dry;
it is simple to implement.

1. A method for controlling a treatment device for treating a windshield of a vehicle,
said treatment device comprising at least one wiping system comprising at least one spraying device having at least one orifice, through which a hydrophobic liquid can be sprayed onto said windshield,
wherein said control method periodically initiates at least one processing cycle comprising:
retrieving at least one datum representing a state of the vehicle;
processing the at least one retrieved datum representing the state of the vehicle;
checking the fulfilment of at least one criterion for activating the spraying device as a function of the at least one processed datum representing the state of the vehicle;
activating the spraying device if the at least one criterion for activating the spraying device is fulfilled.

2. The control method as claimed in claim 1,
wherein the processing cycle comprises:
retrieving a plurality of data representing a state of the vehicle;
processing the plurality of retrieved data representing a state of the vehicle;
checking the fulfilment of a plurality of criteria for activating the spraying device as a function of the plurality of processed data representing the state of the vehicle;
activating the spraying device if each criterion from among the plurality of criteria for activating the spraying device is fulfilled.

3. The control method as claimed in claim 1,
wherein the step of retrieving the at least one datum representing the state of the vehicle or the plurality of data representing the state of the vehicle is carried out continuously during the processing cycle until the at least one criterion for activating the spraying device or each criterion from among the plurality of criteria for activating the spraying device is fulfilled.

4. The control method as claimed in claim 1,
wherein the at least one datum representing the state of the vehicle or the plurality of data representing the state of the vehicle is selected from among: the surrounding brightness of the vehicle, the position of the vehicle, the operation of the vehicle, the presence of a person in the vicinity of said vehicle or inside said vehicle or the current time.

5. The control method as claimed in claim 4,
wherein the at least one criterion for activating the spraying device is fulfilled when the surrounding brightness of the vehicle is above a threshold or when the position of the vehicle is located or when the vehicle is not operating or when a person is not present in the vicinity of the vehicle or inside said vehicle or when the current time is within a primary time range.

6. The control method as claimed in claim 4,
wherein each criterion from among the plurality of criteria for activating the spraying device is fulfilled when the surrounding brightness of the vehicle is above a brightness threshold and/or when the position of the vehicle is located and/or when the vehicle is not operating and/or when a person is not present in the vicinity of the vehicle or inside said vehicle and/or when the current time is within a primary time range.

7. The control method as claimed in claim 4,
wherein the surrounding brightness of the vehicle is measured by a brightness sensor present on the vehicle.

8. The control method as claimed in claim 4,
wherein the position of the vehicle is located by a position sensor present on the vehicle.

9. The control method as claimed in claim 4,
wherein the vehicle is operating when at least one of these conditions is met:
the accessories of the vehicle are powered on, and
the engine of the vehicle is running.

10. The control method as claimed in claim 4,
wherein the presence of a person in the vicinity of said vehicle is detected by said person activating an opening of the vehicle.

11. The control method as claimed in claim 4,
wherein the presence of a person inside said vehicle is detected by at least one presence sensor inside the passenger compartment of said vehicle.

12. The control method as claimed in claim 4,
wherein the current time is determined by a clock inside the motor vehicle.

13. The control method as claimed in claim 1,
wherein said treatment device further comprises:
a drive motor for said at least one wiping system,
a pipe system connected to said at least one spraying device of said wiping system and to a reservoir, and
at least one pump configured to cause said hydrophobic liquid to circulate in said piping system up to said spraying device of said wiping system, and activating the treatment device in order to spray said hydrophobic liquid onto the windshield comprises:
activating said at least one pump so as to cause said hydrophobic liquid to circulate in said pipe system up to said at least one orifice of said spraying device of the wiping system; and, simultaneously
controlling said drive motor so as to cause said wiping system to move on said windshield.

14. A control system for a treatment device for treating a windshield of a vehicle,
said treatment device comprising at least one wiping system comprising at least one spraying device having at least one orifice, through which said hydrophobic liquid can be sprayed onto said windshield,
wherein said control system comprises at least one device for detecting at least one datum representing a state of the vehicle; and an electronic control unit configured for:
processing the at least one retrieved datum representing the state of the vehicle;
checking the fulfilment of at least one criterion for activating the spraying device as a function of the at least one processed datum representing the state of the vehicle; and
activating the spraying device if the at least one criterion for activating the spraying device is fulfilled.
